(19) United States
(12) Patent Application Publication
(10) Pub. No.: US 2024/0083125 A1
(43) Pub. Date: Mar. 14, 2024

(54) TIRE DATA PROCESSING DEVICE AND TIRE DATA PROCESSING METHOD

(71) Applicant: The Yokohama Rubber Co., LTD., Kanagawa (JP)

(72) Inventors: Shunya HIDANO, Hiratsuka-shi (JP); Daisen HAYASHI, Hiratsuka-shi (JP)

(21) Appl. No.: 18/460,199

(22) Filed: Sep. 1, 2023

(30) Foreign Application Priority Data
Sep. 9, 2022 (JP) 2022-143705

(51) Int. Cl. B29D 30/00

(52) U.S. Cl. CPC B29D 30/0061; B29D 2030/0066

(57) ABSTRACT

A tire data processing device includes: a data acquisition unit to acquire surface shape data indicating a tire surface shape; a reference point setting unit to set a reference point having a radial direction value predetermined at each of a plurality of axial positions in a tire axial direction; a symmetrical reference point selection unit to select, from a plurality of the reference points, a pair of reference points disposed at symmetrical axial positions with respect to a tire equatorial plane; a reference point replacement unit to replace one or both of the pair of reference points such that radial direction values of the pair of reference points are coincident with each other; and a comparison result generation unit to compare the pair of reference points having the coincident radial direction value with a measurement point cloud of the surface shape data to generate a comparison result predetermined.

### CROSS-REFERENCE TO RELATED APPLICATIONS

This application claims priority pursuant to 35 U.S.C. 119(a) to Japanese Application No. 2022-143705, filed Sep. 9, 2022, which application is incorporated herein by reference in its entirety.

### TECHNICAL FIELD

The present technology relates to a tire data processing device and a tire data processing method and particularly relates to a tire data processing device and a tire data processing method that can accurately compare uneven surface shapes of a tread surface on left and right sides of a tire.

### BACKGROUND ART

Technologies described in International Patent Publication Nos. WO 2017/17555 and WO 2015/083442 are known tire data processing devices that evaluate a surface shape of a tire on the basis of three-dimensional data obtained by measuring the surface shape of the tire.

### SUMMARY

The present technology provides a tire data processing device and a tire data processing method that can accurately compare uneven surface shapes of a tread surface on left and right sides of a tire.

A tire data processing device according to an embodiment of the present technology includes: a data acquisition unit configured to acquire surface shape data indicating a tire surface shape; a reference point setting unit configured to set a reference point having a radial direction value predetermined at each of a plurality of axial positions in a tire axial direction; a symmetrical reference point selection unit configured to select, from a plurality of the reference points, a pair of reference points disposed at symmetrical axial positions with respect to a tire equatorial plane; a reference point replacement unit configured to replace one or both of the pair of reference points such that radial direction values of the pair of reference points are coincident with each other; and a comparison result generation unit configured to compare the pair of reference points having the coincident radial direction value with a measurement point cloud of the surface shape data to generate a comparison result predetermined.

A tire data processing method according to an embodiment of the present technology includes: a data acquisition step of acquiring surface shape data indicating a tire surface shape; a reference point setting step of setting a reference point having a predetermined radial direction value at each of axial positions in a tire axial direction; a symmetrical reference point selection step of selecting, from a plurality of the reference points, a pair of reference points disposed at symmetrical axial positions with respect to a tire equatorial plane; a reference point replacement step of replacing one or both of the pair of reference points such that radial direction values of the pair of reference points are coincident with each other; and a comparison result generation step of comparing the pair of reference points having the coincident radial direction value with a measurement point cloud of the surface shape data to generate a comparison result predetermined.

The tire data processing device and the tire data processing method according to an embodiment of the present technology allow an evaluation value indicating a surface shape of a tire (i.e., a difference ΔZ between radial direction values Z) to be calculated with respect to the reference points Pp, Pq′ disposed at symmetrical axial positions with respect to the tire equatorial plane CL and having the same radial direction value Z1 and thus have the advantage that uneven surface shapes of a tread surface on left and right sides of the tire can be accurately compared.

### BRIEF DESCRIPTION OF DRAWINGS

FIG. 1 is a block diagram illustrating a tire data processing device according to an embodiment of the technology.

FIG. 2 is an explanatory diagram illustrating a measuring device that measures a tire surface shape.

FIG. 3 is a cross-sectional view in a tire meridian direction illustrating a tire to be measured.

FIG. 4 is a flowchart illustrating a tire data processing method according to the embodiment.

FIG. 5 is an explanatory diagram of the flowchart illustrated in FIG. 4.

FIG. 6 is an explanatory diagram of the flowchart illustrated in FIG. 4.

FIG. 7 is an explanatory diagram of the flowchart illustrated in FIG. 4.

FIG. 8 is an explanatory diagram of the flowchart illustrated in FIG. 4.

FIG. 9 is an explanatory diagram of the flowchart illustrated in FIG. 4.

FIG. 10 is an explanatory diagram of the flowchart illustrated in FIG. 4.

FIG. 11 is an explanatory diagram of the flowchart illustrated in FIG. 4.

FIG. 12 is an explanatory diagram of the flowchart illustrated in FIG. 4.

FIG. 13 is an explanatory diagram illustrating an example of a comparison result in the tire data processing method described above.

FIG. 14 is an explanatory diagram illustrating an example of a comparison result in the tire data processing method described above.

FIG. 15 is an explanatory diagram illustrating a modified example of the tire data processing method illustrated in FIG. 4.

FIG. 16 is an explanatory diagram illustrating a modified example of the tire data processing method illustrated in FIG. 4.

### DETAILED DESCRIPTION

Embodiments of the technology will be described in detail below with reference to the drawings. Note that the technology is not limited to the embodiments.

Additionally, constituents of the embodiments include constituents that are substitutable and are obviously substitutes while maintaining consistency with the embodiments of the technology. Additionally, a plurality of modified examples described in the embodiments can be combined in a discretionary manner within the scope apparent to one skilled in the art.

### Tire Data Processing Device

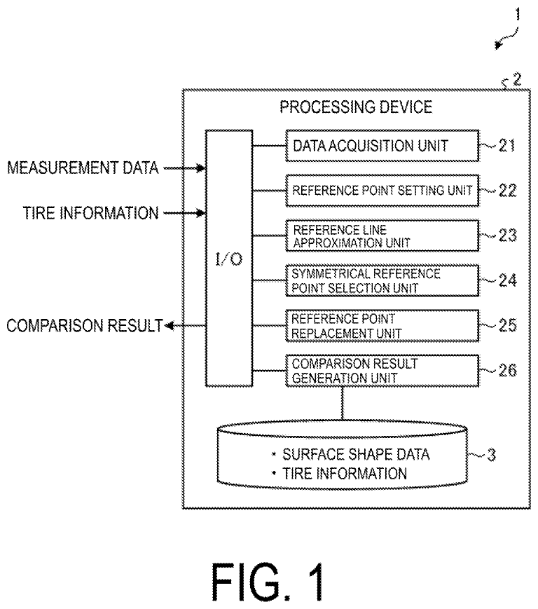

FIG. 1 is a block diagram illustrating a tire data processing device 1 according to an embodiment of the technology.

The tire data processing device 1 includes a control device 2, a storage device 3, a display device such as a monitor (not illustrated), and an input device such as a keyboard or a mouse (not illustrated). The control device 2 is a device that comprehensively controls the operation of the tire data processing device 1, and is composed of, for example, a personal computer (PC) including a central processing unit (CPU), a read-only memory (ROM), and a random-access memory (RAM). The control device 2 includes a data acquisition unit 21 configured to acquire surface shape data indicating a tire surface shape, a reference point setting unit 22 configured to set a reference point having a radial direction value predetermined, a reference line approximation unit 23 configured to approximate a reference line, which is a set of reference points, by a predetermined approximation curve in accordance with predetermined tire information, a symmetrical reference point selection unit 24 configured to select, from a plurality of reference points P, a pair of reference points disposed at symmetrical axial positions with respect to a tire equatorial plane CL, a reference point replacement unit 25 configured to replace one or both of the pair of reference points such that the radial direction values of the pair of reference points are coincident with each other, and a comparison result generation unit 26 configured to compare the pair of reference points having the coincident radial direction value with a measurement point cloud of the surface shape data to generate a comparison result predetermined, which are described later. Specifically, the CPU of the control device 2 reads and executes various programs, achieving these functions. The storage device 3 is a device that stores various programs and data used for processing in the control device 2, and is composed of, for example, a non-volatile memory or a magnetic storage device built in or externally attached to the PC.

### Measuring Device

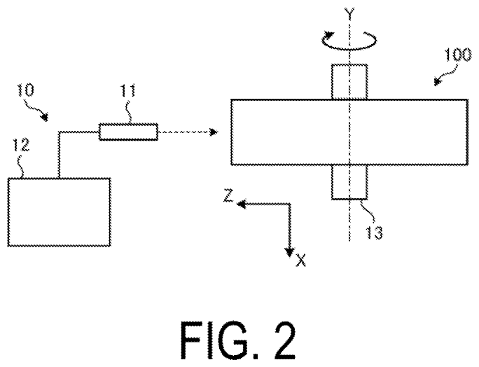

FIG. 2 is an explanatory diagram illustrating a measuring device 10 that measures a tire surface shape. FIG. 2 illustrates an appearance of measuring a tread surface shape of a test tire 100 by using the measuring device 10.

The measuring device 10 is a three-dimensional analyzer, and includes a distance sensor 11, a processing device 12, and a spindle 13 (see FIG. 2). In the measuring device 10, the distance sensor 11 measures a relative distance (Z) of the tire surface at a plurality of measurement points while the spindle 13 moves the tire 100 to be measured in a tire axial direction (X) and rotates the tire 100 in a tire circumferential direction (Y). Then, the processing device 12 generates predetermined measurement data in accordance with an output signal from the distance sensor 11. For example, TIRE360 available from Starrett-Bytewise can be employed for such a measuring device 10.

### Tire

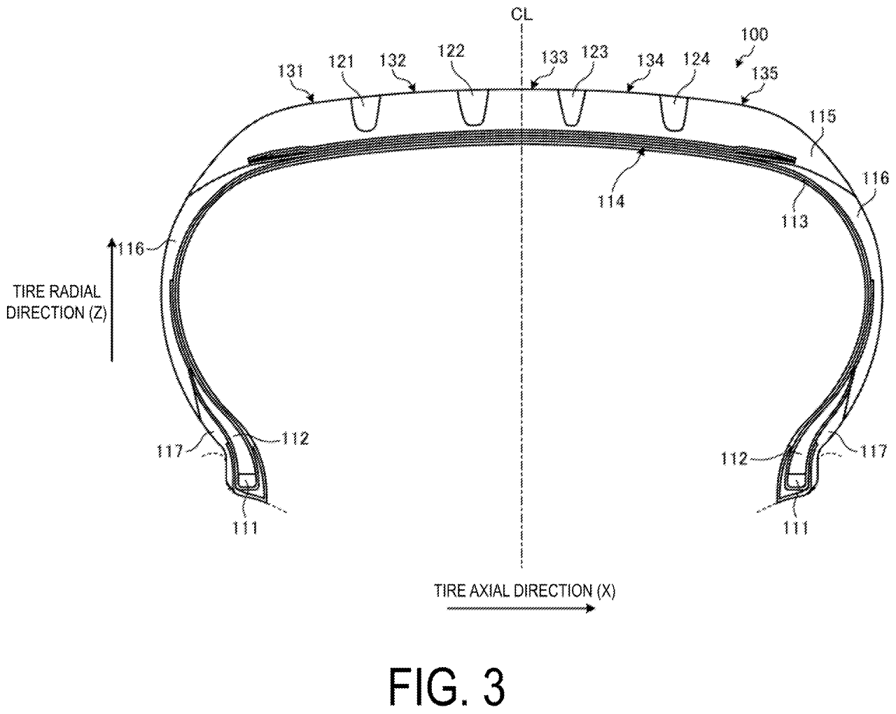

FIG. 3 is a cross-sectional view in a tire meridian direction illustrating the tire 100 to be measured. The same drawing illustrates a cross-sectional view of a half region in a tire radial direction. Here, a tire for a passenger vehicle will be described as an example.

In FIG. 3, the cross-section in the tire meridian direction is defined as a cross-section of the tire taken along a plane that includes a tire rotation axis (not illustrated). The tire equatorial plane CL is defined as a plane that passes through a midpoint of a tire cross-sectional width specified by the Japan Automobile Tyre Manufacturers Association Inc. (JATMA) and is perpendicular to the tire rotation axis. The tire axial direction is defined as a direction parallel to the tire rotation axis, and the tire radial direction is defined as a direction perpendicular to the tire rotation axis.

As illustrated in FIG. 3, the tire 100 has an annular structure centered on the tire rotation axis and includes a pair of bead cores 111, 111, a pair of bead fillers 112, 112, a carcass layer 113, a belt layer 114, a tread rubber 115, a pair of sidewall rubbers 116, 116, and a pair of rim cushion rubbers 117, 117.

The pair of bead cores 111, 111 each include one or more of bead wires made of steel and wound up annularly and multiply, are embedded in bead portions, and constitute cores of the left and right bead portions. The pair of bead fillers 112, 112 are each disposed on an outer circumference of the pair of bead cores 111, 111 in the tire radial direction and reinforce the bead portions.

The carcass layer 113 has a single layer structure including one carcass ply or a multilayer structure including a plurality of carcass plies layered, extends in a toroidal shape between the left and right bead cores 111, 111, and constitutes the backbone of the tire.

The belt layer 114 is formed by layering a plurality of belt plies (reference sign omitted in drawings), and is disposed around an outer circumference of the carcass layer 113. The belt plies include a pair of cross belts and a belt cover.

The tread rubber 115 is disposed on the outer circumference of the carcass layer 113 and the belt layer 114 in the tire radial direction and constitutes a tread portion of the tire 100. The pair of sidewall rubbers 116, 116 are disposed on an outer side of the carcass layer 113 in the tire axial direction and constitute left and right sidewall portions. The pair of rim cushion rubbers 117, 117 extend from an inner side in the tire radial direction of the left and right bead cores 111, 111 and turned back portions of the carcass layer 113 toward an outer side in the tire axial direction, and constitute rim fitting surfaces of the bead portions.

As illustrated in FIG. 3, the tire 100 includes a plurality of circumferential grooves 121 to 124 and a plurality of land portions 131 to 135 defined by the circumferential grooves 121 to 124.

### Tire Data Processing Method

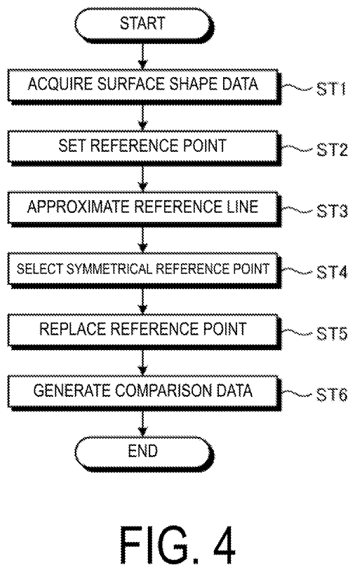

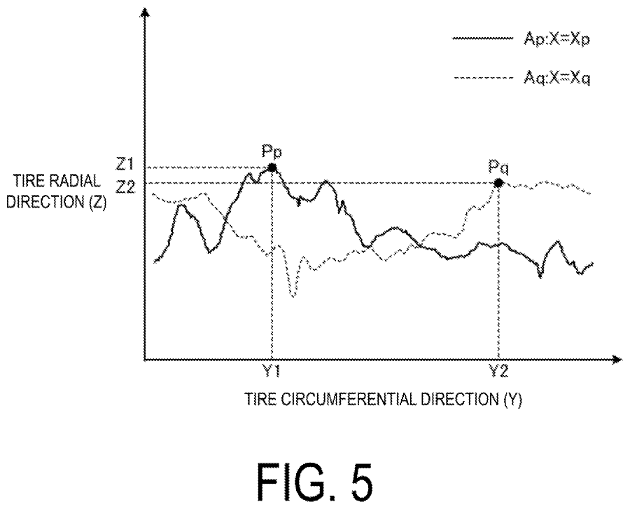

FIG. 4 is a flowchart illustrating a tire data processing method according to the embodiment. FIGS. 5 to 12 are each an explanatory diagram of the flowchart illustrated in FIG. 4. Here, as a first application example, a processing method of measuring a tread surface shape of a tire in the early to intermediate stage of wear and generating a comparison result regarding an amount of wear will be described.

In step ST1, the data acquisition unit 21 acquires surface shape data indicating a tire surface shape. Specifically, the storage device 3 stores the measurement data acquired from the measuring device 10 described above, and the data acquisition unit 21 reads the measurement data and acquires the surface shape data. The data acquisition unit 21 may also directly acquire the measurement data from the measuring device 10.

The surface shape data is data of a measurement point cloud A obtained by subdividing the tread surface of the tire in the tire axial direction, the tire circumferential direction, and the tire radial direction, and includes data of each measurement point A (X, Y, Z) represented by an axial direction value X (X=X1, X2, . . . , Xn) indicating an axial position, a circumferential direction value Y (Y=Y1, Y2, . . . , Ym) indicating a circumferential position, and a radial direction value Z indicating a radial position. Specifically, the tread surface of the tire is divided into n axial positions in the tire axial direction and into m circumferential positions in the tire circumferential direction. Then, the radial direction value Z at each position of the tread surface is measured and acquired. For example, in the embodiment, the number of divisions n in the tire axial direction is 344, and the number of divisions m in the tire circumferential direction is 4096. The number of divisions n in the tire axial direction and the number of divisions m in the tire circumferential direction can be selected as appropriate depending on the specification of the measuring device.

In step ST2, the reference point setting unit 22 sets a reference point P having a predetermined radial direction value Z at each of a plurality of axial positions in the tire axial direction. The radial direction value Z of the reference point P is selected or calculated from radial direction values Z of a measurement point cloud A in a predetermined region in the tire circumferential direction (that is, part or the whole of the range of the circumferential direction value Y) in the measurement point cloud A of the surface shape data having any axial direction value X. The radial direction value Z of the reference point P may also be selected as, for example, the maximum value of the radial direction values Z of the measurement point cloud A at each axial position, or may be selected on another basis.

For example, in the embodiment, the radial direction value Z of the reference point P is selected as the maximum value of the radial direction values Z of a measurement point cloud A in the entire region in the tire circumferential direction in the measurement point cloud A of the surface shape data having any axial direction value X, that is, as a radial direction value of a position at which the wear depth is shallowest. Specifically, the tire in the early to intermediate stage of wear is worn unevenly, and thus the radial direction values Z are uneven in the tire circumferential direction as shown in FIG. 5. Also, in measurement point clouds Ap, Aq having different axial direction values Xp, Xq, respectively, radial direction values Z are not coincident with each other and are uneven. Therefore, measurement points having the maximum values Z1, Z2 of the radial direction values Z are respectively selected from the measurement point clouds Ap, Aq having any axial direction values Xp, Xq, respectively, and are respectively selected as reference points Pp (Xp, Z1), Pq (Xq, Z2). The reference point P at each axial position is set in the entire region in the tire axial direction. This can accurately calculate the evaluation value indicating the surface shape of the tire.

In the configuration described above, the radial direction value Z of the reference point P is selected from the radial direction values Z of the measurement point cloud A in the entire region in the tire circumferential direction. Such a configuration is preferable in that the surface shape can be evaluated in the entire circumference of the tire.

However, no such limitation is intended, and the radial direction value Z of the reference point P may be selected from the radial direction values Z of the measurement point cloud A in a predetermined region in the tire circumferential direction. For example, a region where an angle θ in the tire circumferential direction is in a range of 10 degrees or more and 130 degrees or less may be defined, and the radial direction value Z of the reference point P may be selected or calculated from the radial direction values Z of the measurement point cloud A in this region. This can evaluate the surface shape of the tire in a region close to the human viewing angle (10 degrees to 130 degrees). Note that the “angle θ in the tire circumferential direction” is defined as an angle about the tire rotation axis.

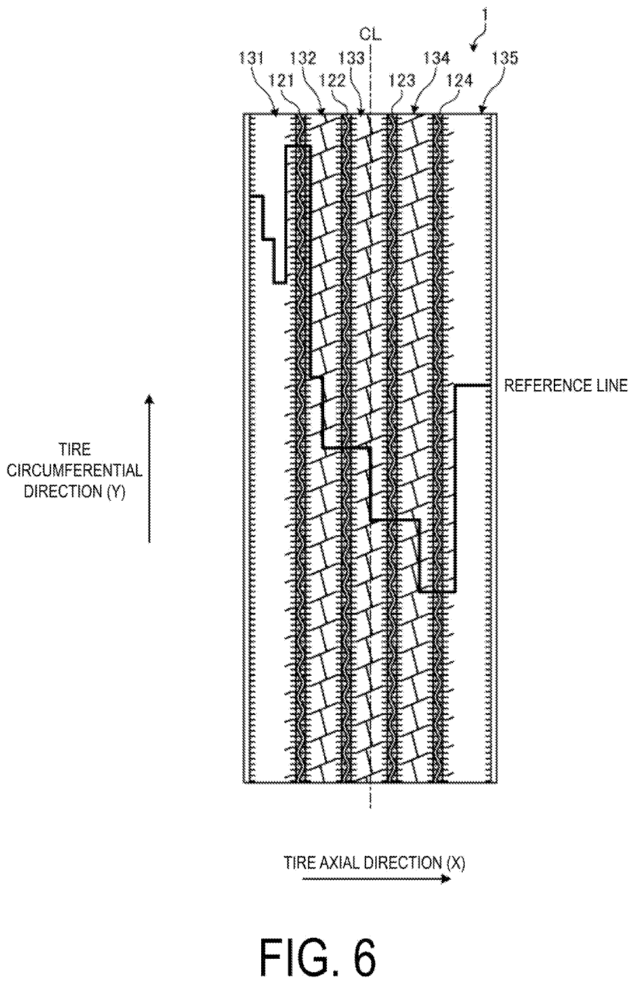

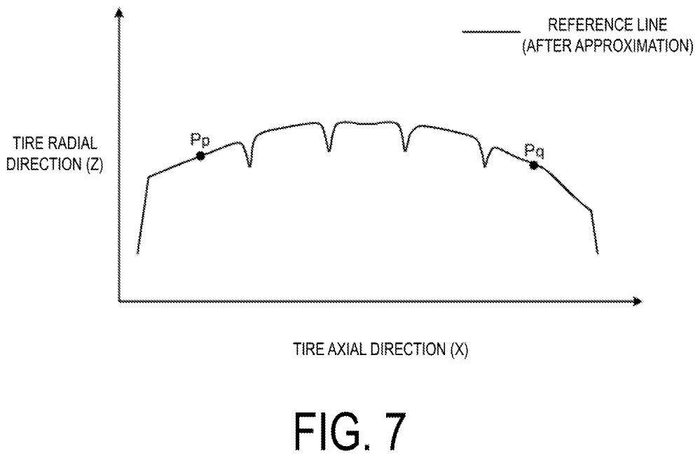

As shown in FIG. 7 described below, the plurality of reference points set in step ST2 are arranged with the tire axial direction and the tire radial direction defined as orthogonal axes and thus are arranged in a row in the tire axial direction to form one reference line (a set of the reference points). The tire data processing device 1 displays the reference line on the display device (not illustrated), and thus a user can visually grasp the contour line of the tire surface shape extracted on a predetermined basis. In a plan view of the tread surface as illustrated in FIG. 6, since the reference points P at positions in the tire axial direction are non-uniformly generated in the tire circumferential direction, a reference line connecting these reference points has a step shape.

In step ST3, the reference line approximation unit 23 approximates the reference line, which is a set of the reference points P, by the predetermined approximation curve in accordance with the predetermined tire information.

Specifically, the radial direction values Z of the reference points P are corrected such that all of the reference points P are arranged along a single approximation curve in each of the ground contact regions of the tire (i.e., the road contact surfaces of the land portions 131 to 135 defined by the circumferential grooves 121 to 124). This allows the arrangement state of a reference point cloud Pin the ground contact region of the tire to be smoothed. The approximation curve may be calculated in accordance with the radial direction value Z of the reference point P in each ground contact region by a known mathematical method, or may be set as appropriate by a user. FIG. 7 shows the approximated and smoothed reference line. The tire information includes, for example, information such as the positions of the circumferential grooves 121 to 124 (see FIGS. 3 and 6) on the tread surface, the position of the tire equatorial plane CL, the position of a tread edge (reference sign omitted in drawings), and tire specifications such as tire size and groove depth.

For example, in the embodiment, the tire data processing device 1 displays the reference line (set of the reference points P) generated in step ST3 on the display device (not illustrated), and a user visually recognizes the displayed reference line and inputs the tire information such as the positions of the circumferential grooves 121 to 124. Then, the set of the reference points P is corrected and approximated in accordance with the inputted tire information to be present on the predetermined approximation curve.

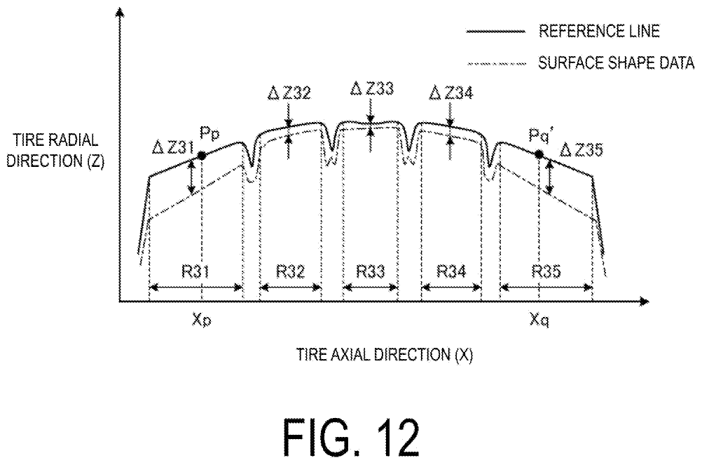

Specifically, the reference line approximation unit 23 defines, in accordance with the designation of the positions of the circumferential grooves 121 to 124 on the tread surface and the position of the tread edge, the ground contact region of the tire (axial regions R31 to R35 described below, see FIG. 12). Then, the reference line approximation unit 23 corrects the radial direction value Z of the reference point P largely separated from the adjacent reference point in the tire radial direction such that the reference points P in the ground contact region of the tire are arranged along the single approximation curve. Regarding whether the radial direction value Z needs to be corrected, for example, when the difference between the radial direction values Z of the adjacent reference points P is equal to or greater than a predetermined threshold value, the radial direction value Z of the separated reference point P may be corrected by the reference line approximation unit 23 or may be visually determined and corrected as appropriate by a user. This allows the reference line on the ground contact surface of each of the land portions 131 to 135 to be smoothed.

In addition to the above, the reference line approximation unit 23 may automatically approximate the reference line in accordance with the tire information stored in advance in the storage device 3.

Note that step ST3 described above may be omitted. In this case, the reference point P set in step ST2 (not corrected in step ST3) is used to perform the following processing.

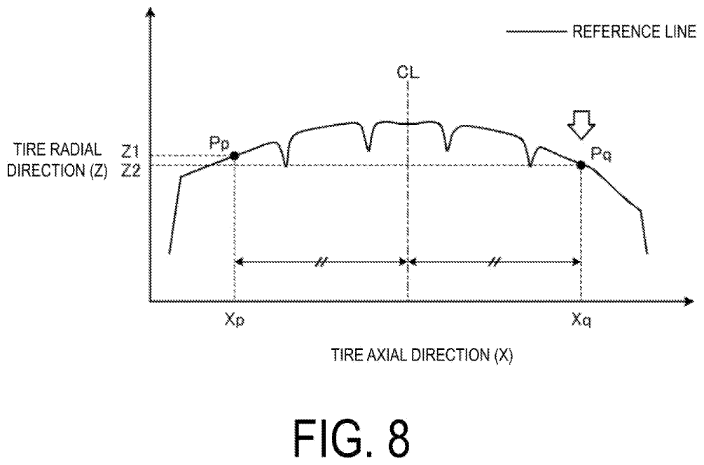

In step ST4, the symmetrical reference point selection unit 24 selects a pair of reference points Pp, Pq disposed at axial positions symmetrical with respect to the tire equatorial plane CL from the plurality of reference points P described above. Specifically, as shown in FIG. 8, any first reference point Pp (Xp, Z1) is selected, and then the second reference point Pq (Xq, Z2) symmetrically disposed with respect to the first reference point Pp centered on the tire equatorial plane CL is selected. Thereafter, the reference points Pp, Pq are associated with each other and stored in the storage device 3. The axial position of the tire equatorial plane CL in the axial direction can be calculated by the symmetrical reference point selection unit 24 in accordance with the surface shape data and the tire information that are stored in the storage device 3.

In step ST5, the reference point replacement unit 25 replaces one or both of the reference points Pp, Pq such that the radial direction values Z1, Z2 of the aforementioned pair of reference points Pp (Xp, Z1), Pq (Xq, Z2) are coincident with each other. In other words, in the tire in the early to intermediate stage of wear, the left and right regions of the tire are worn unevenly, and thus the radial direction values Z1, Z2 of the pair of reference points Pp, Pq are not coincident with each other. Accordingly, one or both of the radial direction values Z1, Z2 are corrected such that the radial direction values Z1, Z2 of the pair of reference points Pp, Pq are coincident with each other, and the reference points Pp, Pq are replaced.

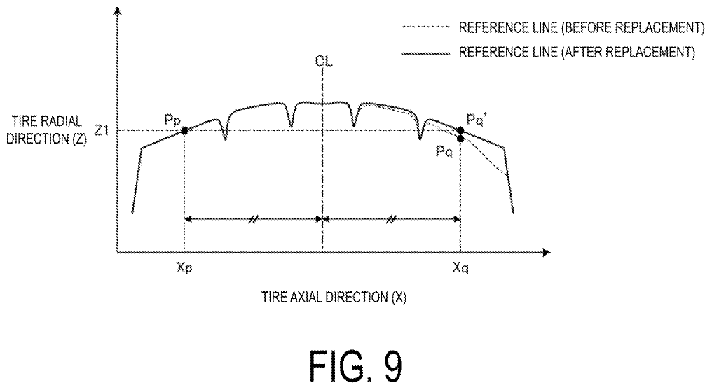

For example, in the graph of FIG. 8, the region on the right side in the drawing is worn more than the region on the left side, and the radial direction value Z2 of the reference point Pq at the second axial position is smaller than the radial direction value Z1 of the reference point Pp at the first axial position. Accordingly, the radial direction values Z1, Z2 of the pair of reference points Pp, Pq are compared with each other, and the smaller radial direction value Z2 is replaced with the larger radial direction value Z1. Specifically, as shown in FIG. 9, the reference point Pq at the second axial position is replaced by a new reference point Pq′ having the replaced radial direction value Z1. Then, the reference points Pp, Pq′ are stored in the storage device 3. Note that FIG. 9 shows the reference line when the replacement processing of the reference point P described above is performed in the entire region in the tire axial direction. Accordingly, in FIG. 9, the reference line (set of the reference points P) has a left-right symmetrical shape with respect to the tire equatorial plane CL.

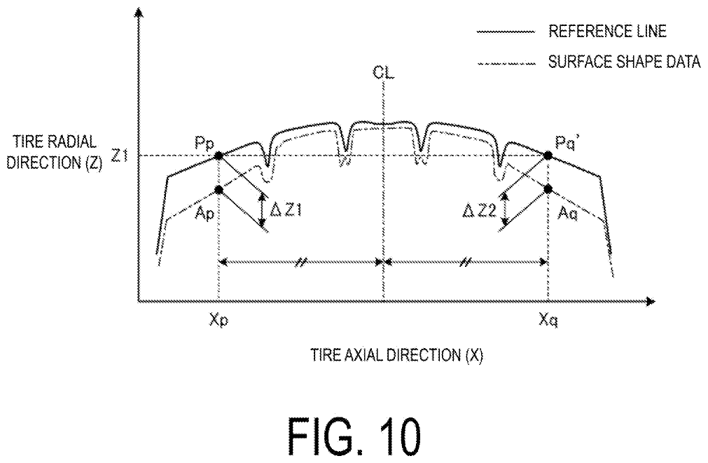

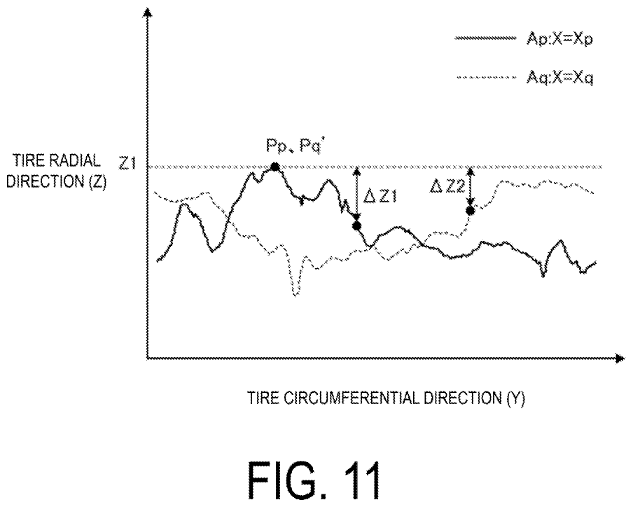

In step ST6, the comparison result generation unit 26 compares the reference points Pp, Pq′ having the coincident radial direction value Z1 with the measurement point clouds Ap, Aq of the surface shape data to generate a predetermined comparison result. In the generation of the comparison result, differences ΔZ1, ΔZ2 (FIGS. 10 and 11) between the radial direction value Z1 of the reference points Pp, Pq′ at the pair of axial positions and the radial direction values Z of the corresponding measurement point clouds Ap, Aq of the surface shape data are calculated. In addition, calculating a difference ΔZ in the radial direction value Z between the reference point P and the measurement point cloud A of the surface shape data in the entire region of the tread surface allows a contour diagram (a diagram in which positions having the same amount of wear are connected by an isoline, the diagram not illustrated) showing the wear state of the tread surface to be created.

For example, as shown in FIG. 12, a plurality of axial regions R31 to R35 corresponding to the ground contact regions of the land portions 131 to 135 (see FIGS. 3 and 6) are defined. Then, in each of the plurality of axial regions R31 to R35, differences ΔZ31 to ΔZ35 in the radial direction value Z between the reference point P and the measurement point cloud A of the surface shape data in the entire region in the tire axial direction and the tire circumferential direction are calculated. Then, the sums ΣΔZ31 to ΣΔZ35 of the differences ΔZ31 to ΔZ35 in the axial regions R31 to R35 are calculated, and a comparison result (not illustrated) is generated. This can compare, for example, the surface shapes (here, total amount of wear) in the axial regions R31, R35 corresponding to the left and right shoulder land portions 131, 135.

The configuration described above allows the evaluation value indicating the surface shape of the tire (the difference ΔZ between the radial direction values Z) to be calculated with respect to the reference points Pp, Pq′ disposed at symmetrical axial positions with respect to the tire equatorial plane CL and having the same radial direction value Z1 and thus uneven surface shapes of the tread surface on the left and right sides of the tire can be accurately compared. For example, as shown in FIG. 8, when the reference points Pp, Pq disposed at symmetrical axial positions have the radial direction values Z1, Z2 different from each other, the reference points Pp, Pq cannot be compared with each other by using a common reference, and thus unevenness of the surface shape of the tire may not be appropriately compared.

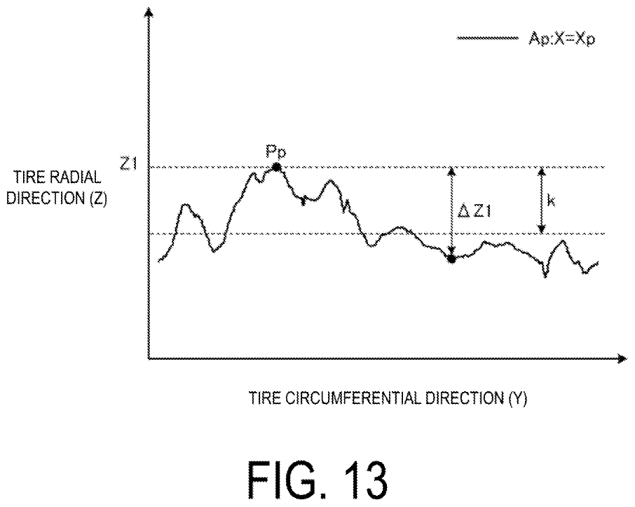

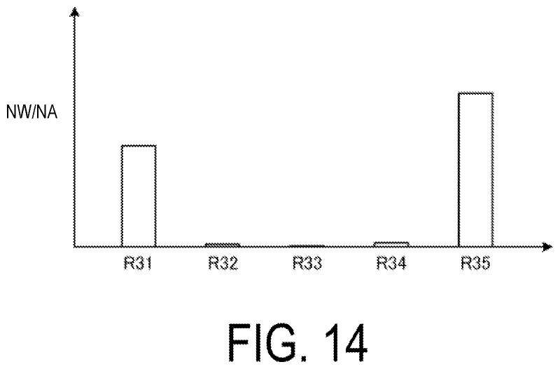

FIGS. 13 and 14 are explanatory diagrams each illustrating an example of a comparison result in the tire data processing method described above. Here, comparison processing of the occurrence frequency of excessive wear in each of the land portions 131 to 135 will be described.

As described above, calculating the difference ΔZ in the radial direction value Z between the reference point P at any axial position and the measurement point A of the surface shape data and calculating the sums ΣΔZ31 to ΣΔZ35 of the differences ΔZ31 to ΔZ35 between the reference point P in the entire region in the tire axial direction and the tire circumferential direction and the surface shape data in each of the axial regions R31 to R35 (see FIG. 12) allows the total amount of wear in the land portions 131 to 135 to be relatively compared.

Comparatively, calculating the difference ΔZ in the radial direction value Z between the reference point P at any axial position and the measurement point A of the surface shape data and calculating a ratio between the total number NW of the measurement points A at which the difference ΔZ exceeds a predetermined threshold value k and the total number NA of the measurement points in each of the axial regions R31 to R35 (see FIG. 12) allows the occurrence frequency of excessive wear in each of the land portions 131 to 135 to be relatively compared.

At the measurement point A at which the difference ΔZ in the radial direction value Z is the predetermined threshold value k or greater, it is determined that excessive wear has occurred. Accordingly, in each of the axial regions R31 to R35 (see FIG. 12), the measurement point A at which the difference ΔZ in the radial direction value Z is less than the predetermined value k is excluded, and the total number NW of the measurement points A at which the difference ΔZ exceeds the predetermined threshold value k is calculated. Then, the ratio between the total number NW of the measurement points A at which excessive wear has occurred and the total number NA of the measurement points in each of the regions R31 to R35 is calculated (see FIG. 14). The ratio NW/NA is grasped as an occurrence rate NW/NA of excessive wear in each land portion. In the example of FIG. 14, the occurrence rate NW/NA of excessive wear in one shoulder land portion 135 is larger than that in the other shoulder land portion 131. In this case, the occurrence rates NW/NA of excessive wear in the pair of shoulder land portions 131, 135 are calculated with respect to the reference points Pp, Pq′ (see FIG. 10) having the same radial direction value Z1 at symmetrical axial positions with respect to the tire equatorial plane CL, and thus non-uniformity of the occurrence rates NW/NA of excessive wear in the pair of shoulder land portions 131, 135 can be accurately compared.

Note that the threshold value k can be selected as appropriate depending on the purpose. In the comparison determination of excessive wear, the threshold value is selected, for example, from a range of 2.5 [mm] to 3.0 [mm].

### Modified Examples

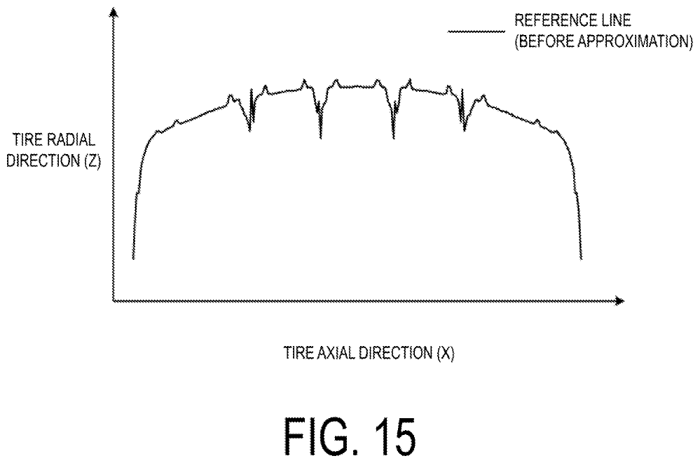

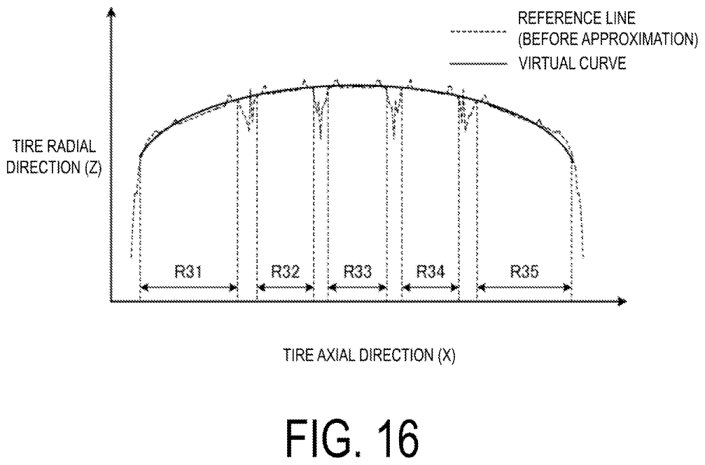

FIGS. 15 and 16 are explanatory diagrams each illustrating a modified example of the tire data processing method illustrated in FIG. 4. Here, as a second application example, a processing method of measuring a tread surface shape of a new tire and generating a comparison result regarding machining accuracy of the tire will be described. Since the flowchart is the same as the flowchart illustrated in FIG. 4, the illustration thereof is omitted.

In step ST1, the data acquisition unit 21 acquires surface shape data indicating a tire surface shape. In step ST2, the reference point setting unit 22 sets a reference point P having a predetermined radial direction value Z at each of a plurality of axial positions in the tire axial direction. Here, the radial direction value Z of the reference point P is selected as the maximum value of the radial direction values Z of the measurement point cloud A in the entire region in the tire circumferential direction in the measurement point cloud A of the surface shape data having any axial direction value X.

In step ST3, the reference line approximation unit 23 approximates the reference line, which is a set of the reference points P, by the predetermined approximation curve in accordance with the predetermined tire information.

In other words, since there is a partially protruded portion due to a vent or overflow on the tread surface of the new tire, the measurement point cloud A of the tire surface shape includes the measurement point A having the radial direction value Z larger than the radial direction value Z of the design tread profile (not illustrated). Accordingly, the reference point P set in step ST2 may have the radial direction value Z having a protruded portion, and the reference line generated in step ST3 has a shape partially protruded at a position in which the protruded portion is generated (see FIG. 15).

Thus, the radial direction value Z of the reference point P is corrected such that all of the reference points P are arranged along a single approximation curve in each of the ground contact regions of the tire (i.e., the road contact surface of each of the land portions 131 to 135 defined by the circumferential grooves 121 to 124). This allows the reference line on the ground contact surface of each of the land portions 131 to 135 is smoothed.

For example, in the embodiment, the tire data processing device 1 displays the reference line (set of the reference points) generated in step ST3 on the display device (not illustrated), and a user visually recognizes the displayed reference line and inputs the tire information such as the position of the circumferential groove. Then, the set of the reference points P is corrected and approximated in accordance with the inputted tire information to be present on the predetermined approximation curve.

Specifically, the reference line approximation unit 23 determines, in accordance with the designation of the positions of the circumferential grooves 121 to 124 on the tread surface and the position of the tread edge, the ground contact region of the tire (the axial regions R31 to R35 described below, see FIG. 12). Thereafter, the reference line approximation unit 23 corrects the radial direction value Z of the reference point P largely separated from the adjacent reference point in the tire radial direction such that the reference points P are arranged along the single approximation curve in each of the ground contact regions of the tire. As shown in FIG. 16, the set of reference points P may be approximated by using a single approximation curve extending over the entire ground contact region of the tire. This can effectively eliminate the influence of the partially protruded portion due to a vent or overflow.

In addition to the above, the reference line approximation unit 23 may automatically approximate the reference line in accordance with the tire information stored in advance in the storage device 3.

In step ST4, the symmetrical reference point selection unit 24 selects a pair of reference points Pp, Pq disposed at axial positions symmetrical with respect to the tire equatorial plane CL from the plurality of reference points P described above. In step ST5, the reference point replacement unit 25 replaces one or both of the reference points Pp, Pq such that the radial direction values Z1, Z2 of the aforementioned pair of reference points Pp (Xp, Z1), Pq (Xq, Z2) are coincident with each other. In other words, even in a new tire, the radial direction values Z1, Z2 of the pair of reference points Pp, Pq may not be coincident with each other. Accordingly, one or both of the radial direction values Z1, Z2 are corrected such that the radial direction values Z1, Z2 of the pair of reference points Pp, Pq are coincident with each other, and the reference points Pp, Pq are replaced.

In step ST6, the comparison result generation unit 26 compares the reference points Pp, Pq′ having the coincident radial direction value Z1 with the measurement point clouds Ap, Aq of the surface shape data to generate a predetermined comparison result. Further, calculating the difference ΔZ in the radial direction value Z between the reference point P and the measurement point cloud A of the surface shape data in the entire region of the tread surface allows a contour diagram (a diagram in which positions having the same amount of recess are connected by an isoline, the diagram not illustrated) showing the machining accuracy of the new tire to be created.

For example, at the measurement point A at which the difference ΔZ in the radial direction value Z is the predetermined threshold value k or greater, it is determined that a deep recess exceeding a permissible range in manufacturing error is generated on the tread surface of the new tire. Accordingly, in each of the plurality of axial regions R31 to R35 (see FIG. 16), the measurement point A at which the difference ΔZ in the radial direction value Z is less than the predetermined threshold value k is excluded, and the total number NW of the measurement points A at which the difference ΔZ exceeds the predetermined value k is calculated. Then, a ratio between the total number NW of the measurement points A at which the deep recess is generated and the total number NA of the measurement points in each of the regions R31 to R35 is calculated. The ratio NW/NA is grasped as an occurrence rate NW/NA of deep recess in each land portion. This can accurately compare the machining accuracy in each land portion of the new tire.

Note that the threshold value k can be selected as appropriate depending on the purpose. In the aforementioned comparison determination of the machining accuracy of the new tire, the threshold value is selected, for example, from a range of 1.0 [mm] to 1.5 [mm].

### Tire Data Processing Program

A tire data processing program to be executed in the tire data processing device 1 of the aforementioned embodiment allows the control device 2 to perform a data acquisition step ST1 of acquiring the surface shape data indicating the tire surface shape, a reference point setting step ST2 of setting a reference point P having a radial direction value predetermined at each of axial positions in the tire axial direction, a symmetrical reference point selection step ST4 of selecting, from a plurality of reference points P, a pair of reference points Pp, Pq disposed at symmetrical axial positions with respect to the tire equatorial plane CL, a reference point replacement step ST5 of replacing one or both of the pair of reference points Pp, Pq such that the radial direction values Z1, Z2 of the pair of reference points Pp, Pq are coincident with each other, and a comparison result generation step ST6 of comparing the pair of reference points Pp, Pq having the coincident radial direction value Z1 with the measurement point cloud A of the surface shape data to generating a comparison result predetermined.

The tire data processing program described above may be stored in a computer connected to a network such as the Internet and may be downloaded via the network and provided. The tire data processing program described above may be provided or distributed via a network such as the Internet. The tire data processing program described above may be incorporated in a ROM or the like in advance and provided.

### Effect

As described above, [1] the tire data processing device 1 includes the data acquisition unit 21 configured to acquire the surface shape data indicating the tire surface shape, the reference point setting unit 22 configured to set the reference point P having a radial direction value predetermined at each of a plurality of axial positions in the tire axial direction, the symmetrical reference point selection unit 24 configured to select, from the plurality of reference points P, the pair of reference points Pp, Pq disposed at symmetrical axial positions with respect to the tire equatorial plane CL, the reference point replacement unit 25 configured to replace one or both of the pair of reference points Pp, Pq such that the radial direction values Z1, Z2 of the pair of reference points Pp, Pq are coincident with each other, and the comparison result generation unit 26 configured to compare the pair of reference points Pp, Pq having the coincident radial direction value Z1 with the measurement point cloud A of the surface shape data to generate a comparison result predetermined (see FIG. 1).

Such a configuration allows the evaluation value (difference ΔZ between the radial direction values Z) indicating the surface shape of the tire to be calculated with respect to the reference points Pp, Pq′ disposed at symmetrical axial positions with respect to the tire equatorial plane CL and having the same radial direction value Z1 and thus has the advantage that uneven surface shapes of the tread surface on the left and right sides of the tire can be accurately compared.

In [2] the tire data processing device 1 according to [1] above, the reference point setting unit 22 selects or calculates the radial direction value Z of the reference point P from radial direction values Z of the measurement point cloud A of the surface shape data. This has the advantage that the evaluation value indicating the tire surface shape can be accurately calculated.

In [3] the tire data processing device 1 according to [2] above, the reference point setting unit 22 selects, as the radial direction values Z of the reference points Pp, Pq, the maximum values Z1, Z1 of the radial direction values Z of the measurement point clouds Ap, Aq of the surface shape data at the plurality of axial positions (see FIG. 5). This has the advantage that the evaluation value indicating the tire surface shape can be accurately calculated.

In [4] the tire data processing device 1 according to any one of [1] to [3] above, the reference point setting unit 22 defines a region in which the angle θ in the tire circumferential direction is in a range of 10 degrees or more and 130 degrees or less, and selects or calculates the radial direction value Z of the reference point P from the radial direction values Z of the measurement point cloud A in the region. This has the advantage that the surface shape of the tire can be evaluated in a region close to the human viewing angle (10 degrees to 130 degrees).

In [5] the tire data processing device 1 according to any one of [1] to [4] above, the comparison result generation unit 26 generates the comparison result by calculates the sums ΣΔZ31, ΣΔZ35 of the differences ΔZ31, ΔZ35 between the radial direction values Z of the plurality of the reference points P in each of the pair of axial regions R31, R35 having the pair of reference points Pp, Pq′ and the radial direction values Z of the measurement point cloud A of the surface shape data. This has the advantage that the surface shapes in the corresponding axial regions R31, R35 can be compared.

In [6] the tire data processing device 1 according to any one of [1] to [5] above, the comparison result generation unit 26 generates the comparison result by calculating the difference ΔZ between the radial direction value Z1 of the pair of reference points Pp, Pq′ and the radial direction value Z of the measurement point cloud A of the surface shape data and excluding the measurement point in the measurement point cloud A at which the difference ΔZ of the radial direction value Z is less than the predetermined threshold value k. This has the advantage that noise is cut and thus accuracy of the comparison result can be improved.

In [7] the tire data processing device 1 according to any one of [1] to [6] above, the tire data processing device 1 includes the reference line approximation unit 23 configured to approximate the reference line, which is a set of the reference points P, by a predetermined approximation curve in accordance with the predetermined tire information. In addition, the reference line approximation unit 23 corrects the radial direction value Z of the reference point P such that the reference point P in the ground contact region of a tire is arranged along the approximation curve. This allows the arrangement state of the reference point cloud P in the ground contact region of the tire is smoothed, and there is an advantage that the surface shape of the tire can be accurately evaluated.

[8] the tire data processing method includes the data acquisition step ST1 of acquiring the surface shape data indicating the tire surface shape, the reference point setting step ST2 of setting a reference point P having a radial direction value predetermined at each of axial positions in the tire axial direction, the symmetrical reference point selection step ST4 of selecting, from a plurality of the reference points P, the pair of reference points Pp, Pq disposed at symmetrical axial positions with respect to the tire equatorial plane CL, the reference point replacement step ST5 of replacing one or both of the pair of reference points Pp, Pq such that the radial direction values Z1, Z2 of the pair of reference points Pp, Pq are coincident with each other, and the comparison result generation step ST6 of comparing the pair of reference points Pp, Pq having the coincident radial direction value Z1 with the measurement point cloud A of the surface shape data to generating a comparison result predetermined (see FIG. 4). Such a configuration allows the evaluation value (difference ΔZ between the radial direction values Z) indicating the surface shape of the tire to be calculated with respect to the reference points Pp, Pq′ disposed at symmetrical axial positions centered on the tire equatorial plane CL and having the same radial direction value Z1 and thus has the advantage that uneven surface shapes of the tread surface on the left and right sides of the tire can be accurately compared.

What is claimed is:

1. A tire data processing device, comprising:
a data acquisition unit configured to acquire surface shape data indicating a tire surface shape;
a reference point setting unit configured to set a reference point having a radial direction value predetermined at each of a plurality of axial positions in a tire axial direction;
a symmetrical reference point selection unit configured to select, from a plurality of the reference points, a pair of reference points disposed at symmetrical axial positions with respect to a tire equatorial plane;
a reference point replacement unit configured to replace one or both of the pair of reference points such that radial direction values of the pair of reference points are coincident with each other; and
a comparison result generation unit configured to compare the pair of reference points having the coincident radial direction value with a measurement point cloud of the surface shape data to generate a comparison result predetermined.

2. The tire data processing device according to claim 1, wherein the reference point setting unit selects or calculates the radial direction value of the reference point from radial direction values of the measurement point cloud of the surface shape data at the plurality of axial positions.

3. The tire data processing device according to claim 2, wherein the reference point setting unit selects, as the radial direction value of the reference point, a maximum value of the radial direction values of the measurement point cloud of the surface shape data at the plurality of axial positions.

4. The tire data processing device according to claim 1, wherein the reference point setting unit defines a region in which an angle in a tire circumferential direction is in a range of 10 degrees or more and 130 degrees or less and selects or calculates the radial direction value of the reference point from the radial direction values of the measurement point cloud in the region.

5. The tire data processing device according to claim 1, wherein the comparison result generation unit generates the comparison result by calculating a sum of differences between the radial direction values of the plurality of the reference points and the radial direction values of the measurement point cloud of the surface shape data in each of a pair of axial regions having the pair of reference points.

6. The tire data processing device according to claim 1, wherein the comparison result generation unit generates the comparison result by calculating a difference between the radial direction value of the pair of reference points and the radial direction value of the measurement point cloud of the surface shape data and excluding a measurement point in the measurement point cloud at which the difference of the radial direction value is less than a predetermined threshold value k.

7. The tire data processing device according to claim 1, comprising a reference line approximation unit that approximates a reference line, which is a set of the reference points, by a predetermined approximation curve in accordance with predetermined tire information, wherein
the reference line approximation unit corrects the radial direction value of the reference point such that the reference point in a ground contact region of a tire is arranged along the approximation curve.

8. A tire data processing method, comprising:
a data acquisition step of acquiring surface shape data indicating a tire surface shape;
a reference point setting step of setting a reference point having a radial direction value predetermined at each of axial positions in a tire axial direction;
a symmetrical reference point selection step of selecting, from a plurality of the reference points, a pair of reference points disposed at symmetrical axial positions with respect to a tire equatorial plane;
a reference point replacement step of replacing one or both of the pair of reference points such that radial direction values of the pair of reference points are coincident with each other; and
a comparison result generation step of comparing the pair of reference points having the coincident radial direction value with a measurement point cloud of the surface shape data to generate a comparison result predetermined.
